(19) United States
(12) Patent Application Publication
(10) Pub. No.: US 2024/0396209 A1
(43) Pub. Date: Nov. 28, 2024

(54) ANTENNA MODULE, ANTENNA SYSTEM, AND RADIO WAVE RECEPTION METHOD

(71) Applicant: Murata Manufacturing Co., Ltd., Nagaokakyo-shi (JP)

(72) Inventor: Takaya NEMOTO, Nagaokakyo-shi (JP)

(73) Assignee: Murata Manufacturing Co., Ltd., Nagaokakyo-shi (JP)

(21) Appl. No.: 18/791,487

(22) Filed: Aug. 1, 2024

Related U.S. Application Data
(63) Continuation of application No. PCT/JP2022/041397, filed on Nov. 7, 2022.

(30) Foreign Application Priority Data
Feb. 3, 2022 (JP) 2022-015645

(51) Int. Cl. H01Q 3/26; H01Q 3/30

(52) U.S. Cl. CPC H01Q 3/267; H01Q 3/30

(57) ABSTRACT

A plurality of antenna elements each include two ports that receive two linearly polarized waves that are orthogonal to each other, wherein polarization directions of the linearly polarized waves received at the two ports of the plurality of antenna elements are different among the plurality of antenna elements. Circuitry processes signals received at the plurality of antenna elements, and when a radio wave arrives, the circuitry compares, among a plurality of ports included in the plurality of antenna elements, reception levels of linearly polarized components received at the plurality of ports, and detects a port with the highest reception level.

### CROSS-REFERENCE TO RELATED APPLICATIONS

The present application is a Continuation Application of PCT Application No. PCT/JP2022/041397, filed on Nov. 7, 2022, which claims priority to Japanese Patent Application No. 2022-015645 filed on Feb. 3, 2022, with the Japan Patent Office, and the entire disclosure of both applications are incorporated herein by reference.

### TECHNICAL FIELD

The present disclosure relates to an antenna module, an antenna system, and a radio wave reception method.

### BACKGROUND ART

A technique for improving the axial ratio of a circularly polarized array antenna in which a plurality of circularly polarized antenna elements are arranged is disclosed in Patent Document 1. In the technique disclosed in Patent Document 1, exciting phases of the plurality of circularly polarized antenna elements are obtained in such a manner that three types of linearly polarized components have the same intensity of radiation electric field, and the plurality of circularly polarized antenna elements are excited at the obtained phases.

### CITATION LIST

### Patent Document

Patent Document 1: Japanese Unexamined Patent Application Publication No. 3-249807

### SUMMARY

### Technical Problem

In communication in which the direction of at least one of a transmission antenna and a reception antenna is not fixed, such as communication between a portable terminal and a base station, a circularly polarized antenna is used as one antenna and a linearly polarized antenna is used as the other antenna. Typically, radio waves transmitted from a circularly polarized antenna do not become perfect circularly polarized waves but become elliptically polarized waves. In the case where an elliptically polarized wave is received at a linearly polarized antenna, the reception sensitivity varies depending on the major-axis direction of the elliptically polarized wave. If the major-axis direction of an incoming elliptically polarized wave can be detected, a deterioration in the reception sensitivity can be suppressed. An object of the present disclosure is to provide an antenna module capable of acquiring information on the major-axis direction of an incoming elliptically polarized wave. Another object of the present disclosure is to provide a radio wave reception method capable of acquiring information on the major-axis direction of an incoming elliptically polarized wave.

In contrast, in the case where a linearly polarized wave is received at a circularly polarized reception antenna, the reception sensitivity may deteriorate depending on the polarization direction of the incoming linearly polarized wave. Still another object of the present disclosure is to provide an antenna system capable of suppressing a deterioration in reception sensitivity in the case where a linearly polarized wave is received at a circularly polarized reception antenna.

### Solution to Problem

According to an aspect of the present disclosure, there is provided an antenna module including:
a plurality of antenna elements each including two ports that receive two linearly polarized waves that are orthogonal to each other, wherein polarization directions of the linearly polarized waves received at the two ports of the plurality of antenna elements are different among the plurality of antenna elements; and
circuitry configured to
   process signals received at the plurality of antenna elements;
   compare, among a plurality of ports included in the plurality of antenna elements, reception levels of linearly polarized components received at the plurality of ports; and detect a port with the highest reception level.

According to another aspect of the present disclosure, there is provided an antenna system including:
a plurality of antenna elements each including two ports and transmitting and receiving, through the two ports, two linearly polarized waves in different polarization directions;
a first antenna module including circuitry configured to supply transmission signals to the plurality of antenna elements and process reception signals received at the plurality of antenna elements; and a second antenna module configured to receive a radio wave transmitted from the first antenna module, measure a reception level, and send back to the first antenna module a signal containing information for identifying the measured reception level, wherein
polarization directions of the linearly polarized waves transmitted from the plurality of antenna elements are different among the plurality of antenna elements, and
the circuitry is configured to
   perform, for each of the plurality of ports, processing for transmitting a linearly polarized wave by supplying a transmission signal to one of the plurality of ports of the plurality of antenna elements and then receive a reply signal sent back from the second antenna module; and
   detect, based on the information contained in the reply signal for identifying the reception level, a port used when the reception level is the highest among the plurality of ports.

### Advantageous Effects

By detecting a port with the highest reception level among a plurality of ports included in a plurality of antenna elements, the major-axis direction of an incoming elliptically polarized wave can be identified within a certain range.

By changing the polarization direction of a linearly polarized wave transmitted from a first antenna module on the basis of a reception level received at a second antenna module, a deterioration in the reception sensitivity at the second antenna module can be suppressed.

### BRIEF DESCRIPTION OF DRAWINGS

FIG. 1 is a schematic view of an antenna module according to a first embodiment.

FIG. 2 is a flowchart illustrating the procedure of a process performed by a processing unit of the antenna module according to the first embodiment.

FIG. 3A is a schematic diagram illustrating the trajectory of a head of an electric field vector on an xy plane of an elliptically polarized wave received at two antenna elements, and FIG. 3B is a diagram indicating the relationship between the major-axis direction of the elliptically polarized wave and a port with the highest reception level.

FIG. 4 is a schematic diagram illustrating the trajectory of a head of an electric field vector on the xy plane of linearly polarized waves received at two antenna elements in an antenna module according to a modification of the first embodiment.

FIG. 5 is a plan view of two antenna elements mounted on an antenna module according to another modification of the first embodiment.

FIG. 6 is a schematic view of an antenna module according to a second embodiment.

FIG. 7 is a flowchart illustrating the procedure of a process performed by a processing unit of the antenna module according to the second embodiment.

FIG. 8 is a schematic diagram for explaining polarization directions of two antenna elements in the antenna module according to the second embodiment.

FIG. 9 is a flowchart illustrating the procedure of a process of the processing unit of the antenna module according to the second embodiment.

FIG. 10 is a schematic diagram illustrating the relationship between an antenna element in an antenna module according to a modification of the second embodiment and a polarization direction of the antenna element.

FIG. 11A is a schematic diagram illustrating the relationship between an antenna element in an antenna module according to another modification of the second embodiment and a polarization direction of the antenna element, and FIGS. 11B and 11C are schematic diagrams in which a first antenna element and a second antenna element are illustrated in an overlapping manner.

FIG. 12 is a schematic diagram illustrating the positional relationship among polarization directions of linearly polarized waves received at 2N ports in the case where N antenna elements overlap.

FIG. 13 is a schematic view of an antenna system according to a third embodiment.

FIG. 14 is a flowchart illustrating the procedure of a process of a first antenna module and a second antenna module in the antenna system according to the third embodiment.

FIG. 15 is a schematic view of an antenna system according to a modification of the third embodiment.

FIGS. 16A to 16D are schematic views of communication systems including the antenna modules according to the embodiments mentioned above.

### DESCRIPTION OF EMBODIMENTS

### First Embodiment

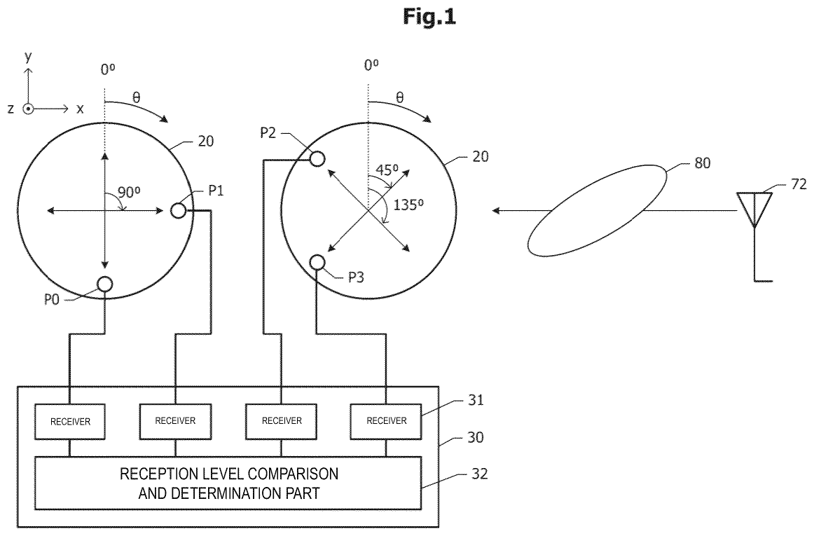

An antenna module according to a first embodiment will be described with reference to FIGS. 1 to 3B. An “antenna module” may be referred to as an “antenna device”.

FIG. 1 is a schematic view of the antenna module according to the first embodiment. The antenna module according to the first embodiment includes two antenna elements 20 and a processing unit 30. A radio wave transmitted from a transmission antenna 72 is received at the two antenna elements 20. The transmission antenna 72 is designed to transmit a circularly polarized wave. However, a radio wave actually transmitted does not become a perfect circularly polarized wave but becomes an elliptically polarized wave 80.

Each of the two antenna elements 20 is, for example, a circular patch antenna and includes two ports. Two ports of one antenna element 20 will be denoted by ports P0 and P1, and two ports of the other antenna element 20 will be denoted by ports P2 and P3. Each of the two ports of the antenna elements 20 is capable of receiving a linearly polarized wave. An xyz orthogonal coordinate system having, as an xy plane, a plane on which the two antenna elements 20 are arranged is defined. When the antenna elements 20 are seen from front, an angle that is tilted clockwise from a y-axis positive direction will be represented by a tilt angle θ. The value of a tilt angle θ when tilted counterclockwise from the y-axis positive direction is negative.

The polarization direction of a linearly polarized wave received at the port P0 of the one antenna element 20 is parallel to the y axis (tilt angle θ of 0 degrees), and the polarization direction of a linearly polarized wave received at the port P1 is parallel to the x axis (tilt angle θ of 90 degrees). The tilt angle θ of the polarization direction of a linearly polarized wave received at the port P2 of the other antenna element 20 is 135 degrees, and the tilt angle θ of the polarization direction of a linearly polarized wave received at the port P3 is 45 degrees.

That is, when attention is paid to an antenna element 20, the polarization direction of a linearly polarized wave received at one port and the polarization direction of a linearly polarized wave received at the other port are orthogonal to each other. Furthermore, the polarization directions of two linearly polarized waves received at the two ports of one antenna element 20 and the polarization directions of two linearly polarized waves received at the two ports of the other antenna element 20 form an angle of 45 degrees.

The processing unit 30 includes four receivers 31 and a reception level comparison and determination part 32. The four receivers 31 are connected to the four ports P0, P1, P2, and P3 of the two antenna elements 20. Reception signals received at the four ports P0, P1, P2, and P3 are input to the four receivers 31. The receivers 31 measure reception levels of reception signals. Reception levels measured at the receivers 31 correspond to intensities of linearly polarized components received at the ports. Measurement results of reception levels are input to the reception level comparison and determination part 32. The functionality of the elements disclosed herein, including but not limited to the processing unit 30 and determination part 32, may be implemented using circuitry or processing circuitry which includes general purpose processors, special purpose processors, integrated circuits, ASICs (“Application Specific Integrated Circuits”), FPGAs (“Field-Programmable Gate Arrays”), conventional circuitry and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited. functionality.

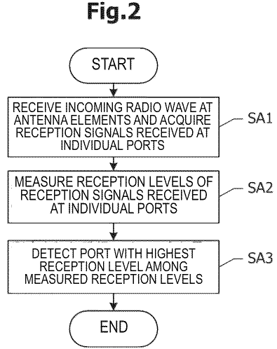

Next, a process performed by the processing unit 30 of the antenna module according to the first embodiment will be described with reference to FIG. 2. FIG. 2 is a flowchart illustrating the procedure of a process (radio wave reception method) performed by the processing unit 30. First, a radio wave transmitted from the transmission antenna 72 (FIG. 1) is received at the two antenna elements 20, and reception signals received at the four ports P0, P1, P2, and P3 are acquired by the receivers 31 of the processing unit 30 (step SA1). The receivers 31 measure reception levels of the reception signals received at the four ports P0, P1, P2, and P3 (step SA2). The measurement results of the reception levels are input to the reception level comparison and determination part 32.

The reception level comparison and determination part 32 compares the reception levels of the reception signals received at the ports P0, P1, P2, and P3 and detects the port at which the highest reception level is obtained (step SA3).

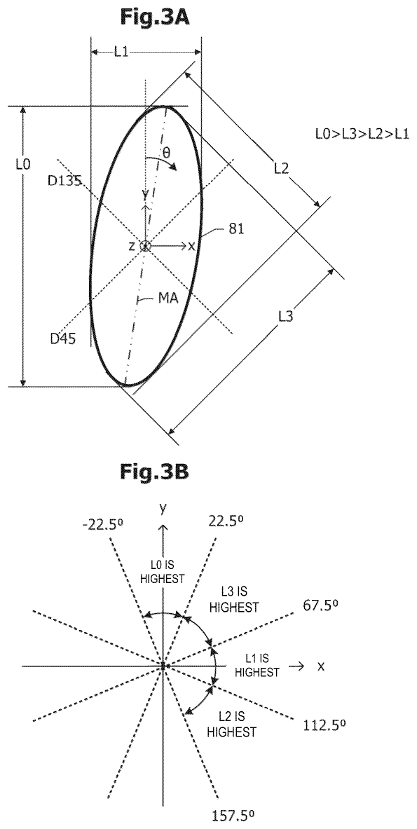

Next, advantageous effects in the first embodiment will be described with reference to FIG. 3A. FIG. 3A is a schematic diagram illustrating a trajectory 81 of the head of an electric field vector on an xy plane of an elliptically polarized wave received by the two antenna elements 20 (FIG. 1). Even if the transmission antenna 72 (see FIG. 1) is designed to transmit a circularly polarized wave, an actually transmitted radio wave typically becomes an elliptically polarized wave. In FIG. 3A, an example in which an major axis MA of the elliptically polarized wave is slightly tilted relative to the y-axis direction is illustrated.

Since the ports P0 and P1 of the one antenna element 20 receive linearly polarized waves in polarization directions that are in parallel to the y direction and the x direction, respectively, reception levels L0 and L1 of the reception signals received at the ports P0 and P1, respectively, correspond to a dimension in the y direction and a dimension in the x direction, respectively, of the trajectory 81. Since the ports P2 and P3 of the other antenna element 20 receive linearly polarized waves in polarization directions that are tilted with tilt angles θ of 135 degrees and 45 degrees, respectively, reception levels L2 and L3 of the reception signals received at the ports P2 and P3, respectively, correspond to a dimension in a direction D135 with the tilt angle θ of 135 degrees and a dimension in a direction D45 with the tilt angle θ of 45 degrees, respectively, of the trajectory 81.

For example, when the tilt angle θ of the major axis MA of the elliptically polarized wave is more than −22.5 degrees and less than 22.5 degrees, the size relationship among the reception levels L0, L1, L2, and L3 is represented by L0>L3>L2>L1. The polarization direction (y direction) of the linearly polarized wave received at the port P0 at which the highest reception level is obtained is closest to the direction of the major axis MA of the elliptically polarized wave compared to the polarization directions of the linearly polarized waves received at the other ports P1, P2, and P3.

FIG. 3B is a diagram indicating the relationship between the direction of the major axis MA of the elliptically polarized wave and a port with the highest reception level. In the case where the reception level L0 is the highest, the tilt angle θ of the major axis MA of the elliptically polarized wave can be identified as being more than −22.5 degrees and less than 22.5 degrees. In the case where the reception level L3 is the highest, the tilt angle θ of the major axis MA of the elliptically polarized wave can be identified as being more than 22.5 degrees and less than 67.5 degrees. In the case where the reception level L1 is the highest, the tilt angle θ of the major axis MA of the elliptically polarized wave can be identified as being more than 67.5 degrees and less than 112.5 degrees. In the case where the reception level L2 is the highest, the tilt angle θ of the major axis MA of the elliptically polarized wave can be identified as being more than 112.5 degrees and less than 157.5 degrees.

When the tilt angle θ of the major axis MA of the elliptically polarized wave can be identified within a certain range, various processes depending on the direction of the major axis MA of the elliptically polarized wave can be optimized.

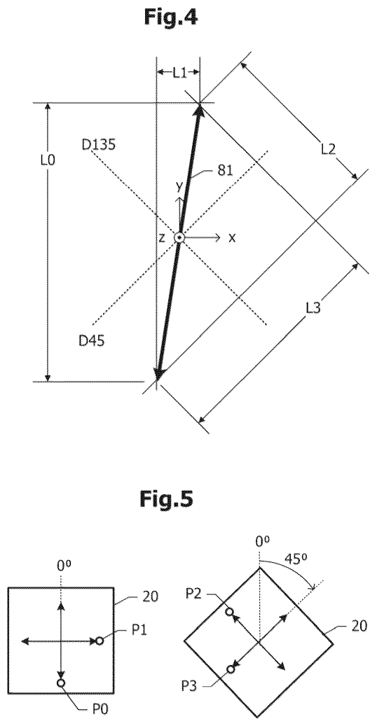

Next, a modification of the first embodiment will be described with reference to FIG. 4. An elliptically polarized wave is received at the two antenna elements 20 in the first embodiment; whereas, a linearly polarized wave is received in the modification of the first embodiment. In this modification, the polarization direction of an incoming linearly polarized wave is estimated.

FIG. 4 is a schematic diagram illustrating a trajectory 81 of the head of an electric field vector on an xy plane of a linearly polarized wave received at the two antenna elements 20 (FIG. 1) of the antenna module according to the modification of the first embodiment. The trajectory 81 is, for example, a straight line extending in a direction slightly displaced from the y-axis direction. The reception levels L0 and L1 of the reception signals received at the ports P0 and P1 of the one antenna element 20 (FIG. 1) correspond to a dimension in the y direction and a dimension in the x direction, respectively, of the trajectory 81. The reception levels L2 and L3 of the reception signals received at the ports P2 and P3 of the other antenna element 20 correspond to a dimension in the direction D135 with the tilt angle θ of 135 degrees and a dimension in the direction D45 with the tilt angle θ of 45 degrees, respectively, of the trajectory 81.

In this modification, on the basis of the size relationship between the reception levels L0, L1, L2, and L3 of the reception signals received at the four ports P0, P1, P2, and P3, the polarization direction of the incoming linearly polarized wave can be identified within a certain range.

Next, another modification of the first embodiment will be described with reference to FIG. 5.

FIG. 5 is a plan view of the two antenna elements 20 mounted on an antenna module according to the modification of the first embodiment. In the antenna module according to the first embodiment, circular patch antennas are used as the antenna elements 20. In contrast, in this modification, square patch antennas are used as the antenna elements 20. The two ports of each of the antenna elements 20 are disposed on line segments whose ends are mid points of two adjacent sides of the antenna element 20 and a geometric center.

The polarization directions of linearly polarized waves received at the two antenna elements 20 are different between the two antenna elements 20 by 45 degrees. In the first embodiment, since the antenna elements 20 are circular, the apparent outlines of the antenna elements 20 do not rotate even if the polarization directions of the antenna elements 20 are rotated. In contrast, in the case where the antenna elements 20 are square as in the modification illustrated in FIG. 5, when the polarization directions of the antenna elements 20 are rotated, the outlines of the antenna elements 20 need to be rotated in the direction of the tilt angle θ.

As in this modification, the shapes of the antenna elements 20 may be square. Furthermore, under the condition that two linearly polarized waves in polarization directions that are orthogonal to each other can be received, the antenna elements 20 may have other shapes. For example, the antenna elements 20 may have a shape obtained by cutting off the four corners of a square in a square fashion.

Next, still another modification of the first embodiment will be described.

In the first embodiment, the polarization directions of linearly polarized waves received at the two antenna elements 20 (FIG. 1) form an angle of 45 degrees between the antenna elements 20. However, the angle between the polarization directions of the linearly polarized waves of the antenna elements 20 is not necessarily 45 degrees. The four ports P0, P1, P2, and P3 of the two antenna elements 20 may be configured to be capable of receiving four linearly polarized waves in different polarization directions. Also in this case, the amount of change in signal level (sum of the amount of gain and the amount of attenuation) and the phase change amount at each of the ports may be set in such a manner that the reception sensitivity in the polarization direction of a linearly polarized wave received at the port at which the reception level of an incoming radio wave is the highest becomes the maximum.

### Second Embodiment

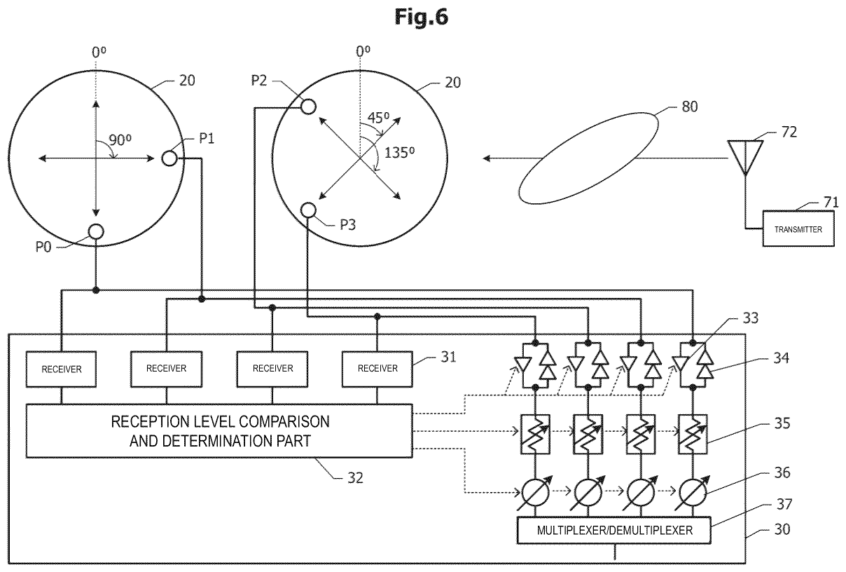

Next, an antenna module according to a second embodiment will be described with reference to FIGS. 6 to 9. Description of configuration features common to those of the antenna module according to the first embodiment described above with reference to FIGS. 1 to 3B will be omitted.

FIG. 6 is a schematic view of the antenna module according to the second embodiment. Similarly to the antenna module according to the first embodiment, the antenna module according to the second embodiment includes two antenna elements 20 and a processing unit 30. In the first embodiment (FIG. 1), the processing unit 30 includes the four receivers 31 and the reception level comparison and determination part 32. In contrast, in the second embodiment, the processing unit 30 includes reception amplifiers 33, transmission amplifiers 34, variable attenuators 35, phase shifters 36, and a multiplexer/demultiplexer 37, in addition to the receivers 31 and the reception level comparison and determination part 32. The reception amplifiers 33, the transmission amplifiers 34, the variable attenuators 35, and the phase shifters 36 are each provided for each of the four ports P0, P1, P2, and P3. The order of connection of the reception amplifiers 33, the transmission amplifiers 34, the variable attenuators 35, and the phase shifters 36 is not limited to the order illustrated in FIG. 6.

The reception level comparison and determination part 32 controls the amounts of gain by the reception amplifiers 33, the amounts of attenuation by the variable attenuators 35, and the phase change amounts by the phase shifters 36. By controlling the amounts of gain by the reception amplifiers 33 and the amounts of attenuation by the variable attenuators 35, the amounts of change in signal level of reception signals are controlled.

In the case where the antenna module receives signals, reception signals received at the four ports P0, P1, P2, and P3 are amplified by the reception amplifiers 33, pass through the variable attenuators 35 and the phase shifters 36, and are input to the multiplexer/demultiplexer 37. The multiplexer/demultiplexer 37 combines the input four reception signals. The combined reception signal is down-converted and then input to a baseband signal processing circuit.

In the case where the antenna module transmits signals, a signal to be transmitted is divided into four signals by the multiplexer/demultiplexer 37. The divided signals pass through the phase shifters 36 and the variable attenuators 35, are amplified by the transmission amplifiers 34, and are supplied to the four ports P0, P1, P2, and P3. At the time of transmission, the gains by the transmission amplifiers 34, the amounts of attenuation by the variable attenuators 35, and the phase change amounts by the phase shifters 36 are controlled.

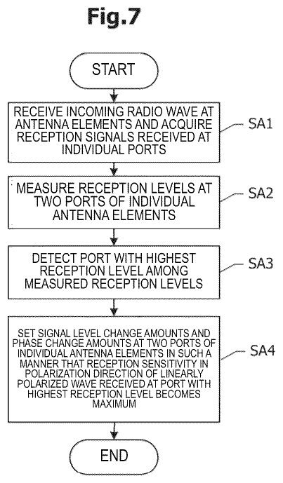

Next, a process performed by the processing unit 30 of the antenna module according to the second embodiment will be described with reference to FIG. 7. FIG. 7 is a flowchart illustrating the procedure of a process (radio wave reception method) performed by the processing unit 30. The procedure of steps SA1 to SA3 is the same as the procedure performed by the processing unit 30 of the antenna module according to the first embodiment (FIG. 2). In step SA3, in the case where there are a plurality of ports at which the highest reception level is obtained, an arbitrary port may be defined as the port with the highest reception level. Alternatively, priority levels may be set in advance for the individual ports, so that the port with the highest priority level among the plurality of ports at which the highest reception level is obtained can be defined as the port with the highest reception level.

When the port with the highest reception level is detected in step SA3, the amounts of change in signal level and the phase change amounts that affect the reception signals received at the two ports of each of the two antenna elements 20 are set in such a manner that the reception sensitivity in the polarization direction of a linearly polarized wave received at the port with the highest reception level becomes the maximum (step SA4). Herein, the amount of change in signal level and the phase change amount that affect a reception signal received at each port may be referred to as the amount of change in signal level and the phase change amount at the port. Specifically, the amounts of gain by the reception amplifiers 33 (FIG. 6), the amounts of attenuation by the variable attenuators 35 (FIG. 6), and the phase change amounts by the phase shifters 36 (FIG. 6) that are connected to the individual ports are set. Thus, the signal levels of the reception signals received at the individual ports change by the set amounts of change in signal level, the phases of the reception signals change by the set phase change amounts, and the reception signals whose signal level and phase have been changed are input to the multiplexer/demultiplexer 37.

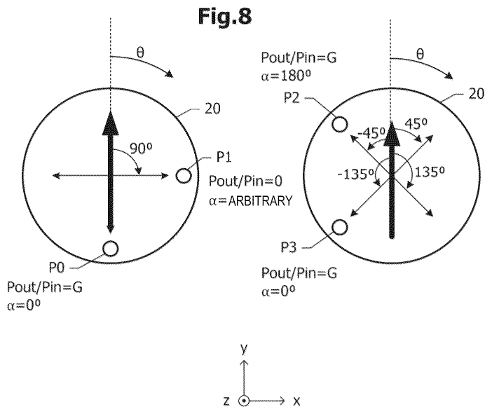

Next, an example in which the amounts of change in signal level and the phase change amounts of reception signals received at the individual ports are controlled in such a manner that the reception sensitivity in the polarization direction of a linearly polarized wave received at the port with the highest reception level becomes the maximum will be described with reference to FIG. 8.

FIG. 8 is a schematic diagram for explaining polarization directions of the two antenna elements 20 of the antenna module according to the second embodiment. The port P0 and the port P1 of one antenna element 20 are disposed at the position with a tilt angle θ of 180 degrees and at the position with a tilt angle θ of 90 degrees, respectively. The tilt angle θ in the polarization direction of a linearly polarized wave received at the port P0 is 0 degrees, and the tilt angle θ in the polarization direction of a linearly polarized wave received at the port P1 is 90 degrees. The port P2 and the port P3 of the other antenna element 20 are disposed at the position with a tilt angle θ of −45 degrees and at the position with a tilt angle θ of −135 degrees, respectively. The tilt angle θ in the polarization direction of a linearly polarized wave received at the port P2 is 135 degrees, and the tilt angle θ in the polarization direction of a linearly polarized wave received at the port P3 is 45 degrees.

The case where the reception level of the linearly polarized wave received at the port P0 is the highest will be described below. Since the tilt angle θ in the polarization direction of the linearly polarized wave received at the port P0 is 0 degrees, the amounts of change in signal level and the phase change amounts at the individual ports are controlled in such a manner that the reception sensitivity for the linearly polarized wave whose tilt angle θ in the polarization direction is 0 degrees becomes the maximum. In FIG. 8, the polarization direction with the tilt angle θ of 0 degrees is indicated by a thick arrow. In order that the signal level of a composite signal obtained by combining reception signals received at the two antenna elements 20 can become the highest, not only polarization directions but also phases of linearly polarized waves received at the two antenna elements 20 need to match. Taking into consideration a phase, the polarization direction of a linearly polarized wave is indicated by an unidirectional arrow in FIG. 8.

In the description provided below, a passage rate will be used in place of the amount of change in signal level controlled by the reception amplifiers 33 and the variable attenuators 35. When the power of an input signal of a reception amplifier 33 is represented by Pin and the power of an output signal of a variable attenuator 35 is represented by Pout, the passage rate can be represented by Pout/Pin. The phase at the port P0 is used as a reference for the phase change amounts at the other ports P1, P2, and P3. That is, phases at the ports P1, P2, and P3 are specified using the phase change amount α, which is based on the phase at the port P0 as a reference.

First, control in the antenna element 20 provided with the ports P0 and P1 will be described. The passage rate at the port P0 is set to G. The phase change amount α at the port P0 is 0 degrees. By setting the passage rate at the port P1 to 0, a reception sensitivity for a linearly polarized wave whose polarization direction has a tilt angle θ of 0 degrees becomes the maximum. Since the passage rate at the port P1 is 0, the phase change amount α at the port P1 is arbitrary.

Next, control in the antenna element 20 provided with the ports P2 and P3 will be described. When the passage rate and the phase change amount α at the port P2 are set to G and 180 degrees, respectively, and the passage rate and the phase change amount α at the port P3 are set to G and 0 degrees, respectively, a reception sensitivity for a linearly polarized wave whose polarization direction has a tilt angle θ of 0 degrees becomes the maximum. Furthermore, by performing setting as mentioned above, phases of reception signals of linearly polarized waves received at the two antenna elements 20 can be made to match.

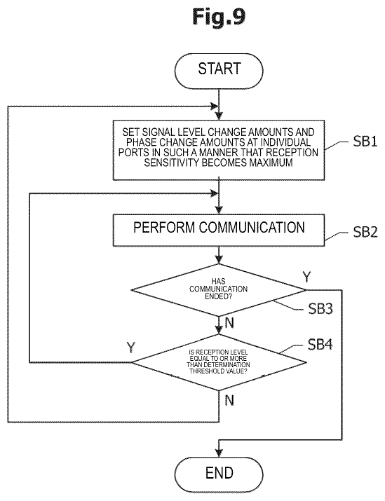

Next, the procedure of a process of the processing unit 30 (FIG. 6) in the case where communication is performed using the antenna module according to the second embodiment will be described with reference to FIG. 9. FIG. 9 is a flowchart illustrating the procedure of a process (radio wave reception method) of the processing unit 30 (FIG. 6).

Before starting communication, the amounts of change in signal level and the phase change amounts α at the individual ports are set in such a manner that the reception sensitivity becomes the maximum (step SB1). Setting of the amounts of change in signal level and the phase change amounts α can be performed based on the procedure illustrated in FIG. 7. After setting of the amounts of change in signal level and the phase change amounts α is performed, actual communication is performed (step SB2). During the period up to the end of the communication, the processing unit 30 determines whether or not the reception level of a reception signal combined by the multiplexer/demultiplexer 37 (FIG. 6) is equal to or more than a determination threshold value (step SB3, SB4). In the case where the reception level is equal to or more than the determination threshold value, the communication continues (steps SB4, SB2). When the reception level reaches below the determination threshold value, the amounts of change in signal level and the phase change amounts α at the individual ports are reset in such a manner that the reception sensitivity becomes the maximum (steps SB4, SB1). That is, the procedure illustrated in FIG. 7 is performed again.

Next, advantageous effects in the second embodiment will be described below.

In the second embodiment, the amounts of change in signal level and the phase change amounts at the four ports P0, P1, P2, and P3 of the two antenna elements 20 are set in such a manner that the reception sensitivity in the polarization direction of a linearly polarized wave received at the port at which the reception level of an incoming radio wave is the highest becomes the maximum. Thus, also in the case where an incoming radio wave is an elliptically polarized wave, the radio wave can be received with a high reception sensitivity.

Furthermore, as described above with reference to FIG. 4, in the antenna module according to the second embodiment, the polarization directions of the antenna elements 20 (FIG. 6) can be adjusted in such a manner that the reception sensitivity becomes the maximum even in the case where an incoming radio wave is a linearly polarized wave and the polarization direction of the linearly polarized wave is unclear.

When a conventional antenna module that receives linearly polarized waves receives a linearly polarized wave in a certain polarization direction, by optimizing the direction of the antenna module, the highest reception level can be achieved. However, if the direction of the antenna module is changed by some factor, the reception level largely changes. In the antenna module according to the second embodiment, if the direction of the antenna module changes and the reception level decreases, the amount of change in signal level and the phase change amount at each port are reset in steps SB4 and SB1 in FIG. 9. Thus, a decrease in the reception level can be suppressed.

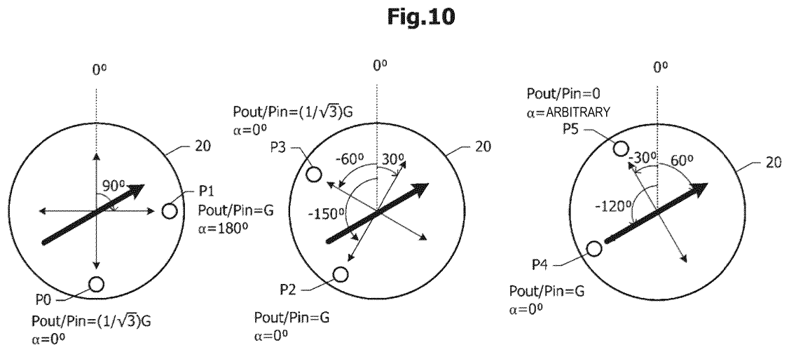

Next, an antenna module according to a modification of the second embodiment will be described with reference to FIG. 10. FIG. 10 is a schematic diagram illustrating the relationship between antenna elements 20 of the antenna module according to the modification of the second embodiment and polarization directions of the antenna elements 20. The antenna module according to the second embodiment includes the two antenna elements 20 (FIG. 6); whereas, the antenna module according to this modification includes three antenna elements 20. The first antenna element 20 includes ports P0 and P1, the second antenna element 20 includes ports P2 and P3, and the third antenna element 20 includes ports P4 and P5.

The ports P0 and P1 of the first antenna element 20 are disposed at positions with the tilt angles θ of 180 degrees and 90 degrees, respectively. The ports P2 and P3 of the second antenna element 20 are disposed at positions with the tilt angles θ of −150 degrees and −60 degrees, respectively. The ports P4 and P5 of the third antenna element 20 are disposed at positions with the tilt angles θ of −120 degrees and −30 degrees, respectively.

The polarization directions of linearly polarized waves received at the ports P0, P2, and P4 of the three antenna elements 20 are different by 30 degrees. For example, the tilt angle θ in the polarization direction of a linearly polarized wave received at the port P0 of the first antenna element 20 is 0 degrees, the tilt angle θ in the polarization direction of a linearly polarized wave received at the port P2 of the second antenna element 20 is 30 degrees, and the tilt angle θ in the polarization direction of a linearly polarized wave received at the port P4 of the third antenna element 20 is 60 degrees.

In the modification illustrated in FIG. 10, the processing unit 30 (FIG. 6) compares reception levels of linearly polarized waves received at the six ports in total and detects the port with the highest reception level. The processing unit 30 sets the amounts of change in signal level and the phase change amounts at the two ports of each of the antenna elements 20 in such a manner that the reception sensitivity in the polarization direction corresponding to the port with the highest reception level becomes the maximum.

Optimal amounts of change in signal level and optimal phase change amounts will be described below with reference to an example of the case where the reception level at the port P4 of the third antenna element 20 is the highest. In this case, the reception sensitivity in the polarization direction with the tilt angle θ of 60 degrees may be set to be the maximum. The passage rate at the port P4 is set to G by using the phase at the port P4 as a reference phase.

In the first antenna element 20, the passage rate and the phase change amount α at the port P0 may be set to (1/(3½)) G and 0 degrees, respectively, and the passage rate and the phase change amount α at the port P1 may be set to G and 180 degrees, respectively. In the second antenna element 20, the passage rate and the phase change amount α at the port P2 may be set to G and 0 degrees, respectively, and the passage rate and the phase change amount α at the port P3 may be set to (1/(3½)) G and 0 degrees, respectively. In the third antenna element 20, the passage rate at the port P5 may be set to 0. The phase change amount α at the port P5 is arbitrary.

As in the modification of the second embodiment illustrated in FIG. 10, the number of the antenna elements 20 may be three. More typically, the number of the antenna elements 20 may be N. N represents an integer of 2 or more. In this case, linearly polarized waves may be received in such a manner that polarization directions of linearly polarized waves received at one ports of the N antenna elements 20 are different between the antenna elements 20 by 180/(2N) degrees.

In the modification of the second embodiment illustrated in FIG. 10, the passage rates at both the port P0 and the port P3 may be set to G. In this case, the first antenna element 20 and the second antenna element 20 also have a sensitivity with respect to a linearly polarized wave (orthogonally polarized wave) that is orthogonal to the polarization direction of the linearly polarized wave received at the port P4. However, in the case where the intensity of the orthogonally polarized wave is very low, a decrease in the sensitivity with respect to the linearly polarized wave in the polarization direction received at the port P4 can be ignored.

That is, in order to maximize the reception sensitivity for the linearly polarized wave in the polarization direction received at the port P4, the phase change amount at each port may be set in such a manner that the phase of a linearly polarized component in the polarization direction received at the port P4 is the same as those of the other ports P0, P1, P2, and P3.

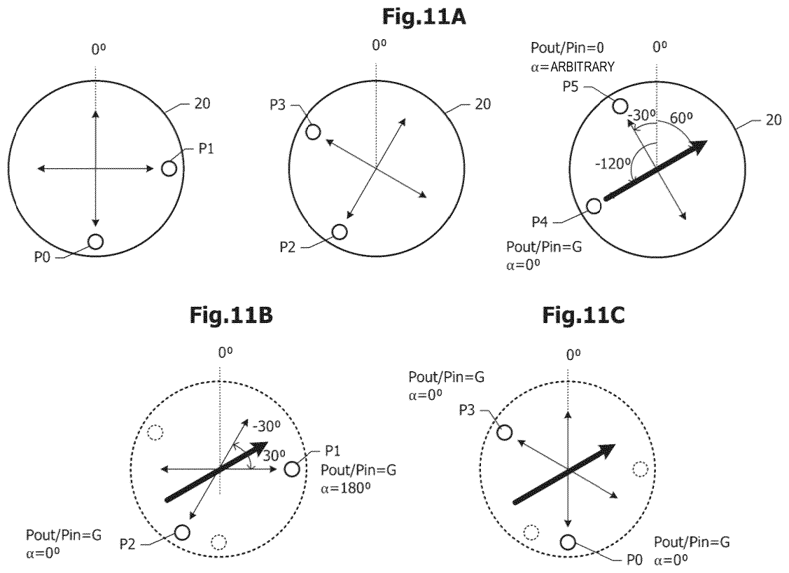

Next, an antenna module according to another modification of the second embodiment will be described with reference to FIGS. 11A, 11B, and 11C.

FIG. 11A is a schematic diagram illustrating the relationship between antenna elements 20 of the antenna module according to the modification of the second embodiment and polarization directions of the antenna elements 20. As in the modification illustrated in FIG. 10, the antenna module according to this modification includes three antenna elements 20. The arrangement of the ports of the three antenna elements 20 is the same as that in the modification illustrated in FIG. 10.

In the modification illustrated in FIG. 10, the reception sensitivity is maximized for each antenna element 20 by adjusting the passage rates and the phase change amounts at the two ports of the antenna element 20. In contrast, in this modification, the reception sensitivity is maximized for the three antenna elements 20 as a whole.

As in the modification described above with reference to FIG. 10, optimal passage rates and optimal phase change amounts will be described below with reference to an example of the case where the reception level at the port P4 of the third antenna element 20 is the highest. As in the modification illustrated in FIG. 10, the passage rate at the port P5 is set to 0.

FIGS. 11B and 11C are schematic diagrams in which the first antenna element 20 and the second antenna element 20 are illustrated in an overlapping manner. Two ports at which linearly polarized waves in two polarization directions with the same absolute value of tilt angle with respect to the polarization direction of the linearly polarized wave received at the port P4 with the highest reception level are received are selected. For example, as illustrated in FIG. 11B, the port P1 of the first antenna element 20 and the port P2 of the second antenna element 20 are selected. In the case where the polarization direction of the linearly polarized wave received at the port P4 is used as a reference, the tilt angle in the polarization direction of the linearly polarized wave received at the port P1 is 30 degrees, and the tilt angle in the polarization direction of the linearly polarized wave received at the port P2 is −30 degrees. Thus, the absolute values of these tilt angles are the same.

Next, a method for combining signals received at the port P1 and the port P2 and maximizing the reception sensitivity for the linearly polarized wave received at the port P4 with the highest reception level will be described. In the description provided below, it is assumed that a radio wave arrives from the boresight direction of an array antenna including the plurality of antenna elements 20. The phase change amounts at the ports P1 and P2 are set in such a manner that the phase of a component in the polarization direction (a direction indicated by a thick arrow in FIG. 11B) of the linearly polarized wave received at the port P4 is the same as those of the ports P1 and P2. Specifically, by using the phase change amount α at the port P4 as a reference, the phase change amount α at the port P1 is set to 180 degrees, and the phase change amount α at the port P2 is set to 0 degrees. The passage rates at the ports P1 and P2 are set to the maximum values of the passage rates at the ports P1 and P2. By performing setting as described above, the reception sensitivity for the case where signals received at the port P1 and the port P2 are combined becomes the maximum.

The case where it is assumed that antenna gains at the port P1 and the port P2 are the same will be described. In the case where the maximum values of the passage rates at the port P1 and the port P2 are the same, when the passage rates and the phase change amounts at the port P1 and the port P2 are set as described above, radio waves emitted from the two antenna elements 20 become linearly polarized waves that are parallel to the polarization direction of the linearly polarized wave received at the port P4 in the far field. In contrast, when radio waves regarded as plane waves are received at the port P1 and the port P2 under the conditions of the passage rates and the phase change amounts described above, the reception sensitivity for the linearly polarized wave in the polarization direction received at the port P4 becomes the maximum, and the reception sensitivity for an orthogonally polarized wave becomes zero.

Next, the case where the antenna gains at the port P1 and the port P2 are different will be described. In the case where the maximum values of the passage rates at the port P1 and the port P2 are the same, even if the passage rates and the phase change amounts at the port P1 and the port P2 are set as described above, radio waves emitted from the two antenna elements 20 are not parallel to the polarization direction of the linearly polarized wave received at the port P4 in the far field. In contrast, when radio waves regarded as plane waves are received at the port P1 and the port P2 under the conditions of the passage rates and the phase change amounts described above, the reception sensitivity for an orthogonally polarized wave for the linearly polarized wave received at the port P4 does not become zero. However, even in this case, the reception sensitivity for the linearly polarized wave in the polarization direction received at the port P4 becomes the maximum.

The passage rates at the port P1 and the port P2 may be set in such a manner that the product of the antenna gain at the port P1 and the passage rate at the port P1 is equal to the product of the antenna gain at the port P2 and the passage rate at the port P2. For example, the passage rate at a port with a smaller antenna gain is set to the maximum, and the passage rate at the other port is set in such a manner that the products of the antenna gains and the passage rates at the two ports are the same. At this time, the reception sensitivity for the linearly polarized wave in the polarization direction received at the port P4 becomes the maximum, and the reception sensitivity for the orthogonally polarized wave becomes zero. Thus, a deterioration in a reception signal of the main polarized wave caused by a reception signal of the orthogonally polarized wave can be suppressed. Setting the passage rate at one port to be less than the maximum value corresponds to reducing a gain by a reception amplifier 33 (FIG. 6). Thus, reception sensitivity can be maximized while impact by an orthogonally polarized wave being reduced, and power consumption can be reduced.

In the case where a sufficient signal level of a reception signal can be secured without setting the passage rate to the maximum value, the passage rate at a port with a smaller antenna gain does not need to be set to be the maximum. Also in this case, the passage rate at the other port may be set in such a manner that the products of antenna gains and passage rates at the two ports are the same.

Similarly, as illustrated in FIG. 11C, the passage rates at the port P0 and the port P3 are both set to G, and the phase change amounts α at the port P0 and the port P3 are both set to 0 degrees. At this time, when radio waves regarded as plane waves are received at the two ports P0 and P3, the reception sensitivity for a linearly polarized wave in the polarization direction (a direction indicated by a thick arrow in FIG. 11C) of the linearly polarized wave received at the port P4 becomes the maximum.

As in this modification, by regarding two ports that are disposed in the two antenna elements 20 as a pair, passage rates and phase change amounts may be adjusted in such a manner that the reception sensitivity at the pair of ports becomes the maximum. In this case, the reception sensitivity can be maximized by setting the passage rates (amounts of change in signal level) of all the ports other than a port (in the example illustrated in FIG. 11A, the port P5) that receives a linearly polarized wave in the polarization direction that is orthogonal to the polarization direction at which the reception sensitivity becomes the maximum to be the same and adjusting only the phase change amounts.

In the description provided above, it is assumed that a radio wave arrives from the boresight direction of an array antenna including the plurality of antenna elements 20. In the case where a main beam of the array antenna including the plurality of antenna elements 20 is tilted from the boresight direction, beam tilt control as well as control for maximizing the reception sensitivity according to the polarization direction may be performed. For example, a plurality of phase conditions are determined based on the phase change amount for maximizing the reception sensitivity according to the polarization direction and the phase change amount set according to the direction of the main beam. One of the phase conditions may be selected on the basis of the direction of the main beam and the polarization direction, and the phase change amount for each port may be set on the basis of the selected phase condition.

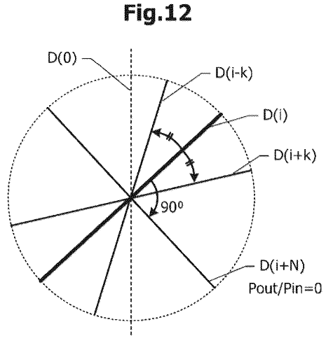

Next, an antenna module according to still another modification of the second embodiment will be described with reference to FIG. 12. In the modification illustrated in FIGS. 11A, 11B, and 11C, the three antenna elements 20 are arranged. In contrast, in the modification illustrated in FIG. 12, N antenna elements are arranged. N represents an integer of 2 or more.

FIG. 12 is a schematic diagram illustrating the positional relationship among polarization directions of linearly polarized waves received at 2N ports in the case where the N antenna elements overlap. In the case where the N antenna elements overlap, the 2N ports are arranged in such a manner that 2N polarization directions are different by 180/(2N) degrees. Serial numbers starting from 0 are allocated to polarization directions in the order in which the tilt angle θ increases clockwise from a reference polarization direction, and the ith polarization direction is denoted by D(i). Herein, i represents an integer of 0 or more and (2N−1) or less.

The case where a polarization direction in which the maximum reception sensitivity is obtained is the ith polarization direction D(i) will be described. Since the 2N polarization directions are distributed with constant angular differences therebetween, there are two polarization directions D(i+k) and D(i−k) that are tilted at the same angle clockwise and counterclockwise, respectively, from the polarization direction D(i). Herein, k represents an integer of 1 or more and (N−1) or less. In the case where i+k reaches N or more, the value obtained by subtracting N from i+k is regarded as the value of i+k. In the case where i−k reaches negative, the value obtained by adding N to i−k is regarded as the value of i−k.

By regarding two ports that receive linearly polarized waves in the two polarization directions D(i+k) and D(i−k) as a pair, passage rates and phase change amounts at the pair of ports are set in such a manner that the reception sensitivity for the linearly polarized wave in the polarization direction D(i) becomes the maximum. Specifically, the passage rates at the two ports are set to be the same. The phase change amounts are set to 0 degrees or 180 degrees to match the phase at the port that receives the linearly polarized wave in the polarization direction D(i).

The passage rate at a port that receives a linearly polarized wave in a polarization direction D(i+N) that is orthogonal to the polarization direction D(i) is set to 0.

As in the modification illustrated in FIG. 12, the passage rates and the phase change amounts at the 2N ports can be set in such a manner that the reception sensitivity for a linearly polarized wave or an elliptically polarized wave of an incoming radio wave becomes the maximum.

As an example of the modification illustrated in FIG. 12, the pass amounts (that is, the amounts of change in signal level) at all the ports may be set to be the same, and only the phase change amounts at the individual ports may be adjusted. In this case, the phase change amounts α may be controlled in such a manner that the phase of a linearly polarized component that is parallel to the polarization direction D(i) of a linearly polarized wave that is received at the port with the highest reception level is the same among all the ports.

Next, still another modification of the second embodiment will be described. In the second embodiment and the modifications described above, polarization directions of the plurality of antenna elements are not the same. However, polarization directions of at least some of the plurality of antenna elements may be the same. For example, a plurality of sets of the two antenna elements 20 illustrated in FIG. 6 may be arranged or a plurality of sets of the three antenna elements 20 illustrated in FIG. 10 may be arranged.

Out of a plurality of antenna elements that have different polarization directions, only antenna elements that have some polarization directions may be arranged. For example, in the example illustrated in FIG. 10, two first antenna elements 20, which include the ports P0 and P1, may be arranged.

In the case where a plurality of antenna elements that have the same polarization direction are arranged, the major-axis direction of an incoming elliptically polarized wave may be detected by extracting N antenna elements 20 that have different polarization directions from all the antenna elements 20 and causing only the N antenna elements 20 to operate.

In the second embodiment (FIG. 6), the receivers 31 and the reception amplifiers 33 are provided separately. However, the functions of the receivers 31 may be implemented by the reception amplifiers 33. For example, reception signals that have been amplified by the reception amplifiers 33 but have not been combined by the multiplexer/demultiplexer 37 may be input to the reception level comparison and determination part 32. In this case, gains by the reception amplifiers 33 need to be the same. In the case where reception signals that have been attenuated by the variable attenuators 35 are input to the reception level comparison and determination part 32, the amounts of attenuation by the variable attenuators 35 need to be the same.

Although power supply lines from the four ports P0, P1, P2, and P3 are branched out and then connected to the processing unit 30 in FIG. 6, the power supply lines may be branched out inside the processing unit 30.

### Third Embodiment

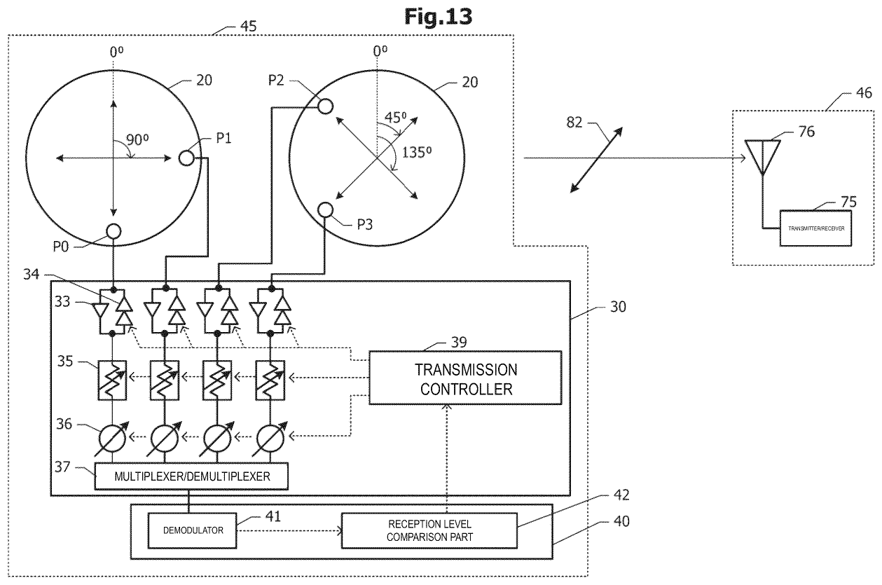

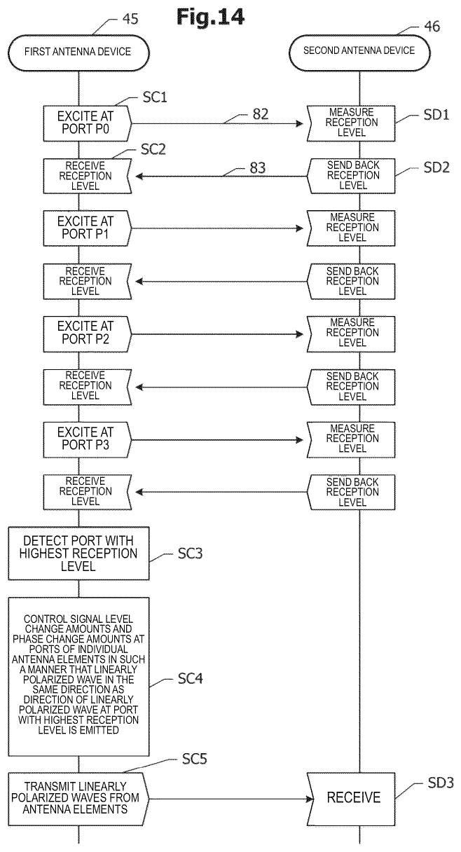

Next, an antenna system according to a third embodiment will be described with reference to FIGS. 13 and 14. Description of configuration features common to those of the antenna module according to the second embodiment described above with reference to FIGS. 6 to 9 will be omitted. In the second embodiment, a deterioration in the reception sensitivity at the time when a circularly polarized wave transmitted from the transmission antenna is received at a linearly polarized antenna element is suppressed. In contrast, in the third embodiment described below, a deterioration in the reception sensitivity at the time when a linearly polarized wave transmitted from a transmission antenna is received at a circularly polarized antenna element is suppressed.

FIG. 13 is a schematic view of the antenna system according to the third embodiment. The antenna system according to the third embodiment includes a first antenna module 45 and a second antenna module 46.

The first antenna module 45 includes two antenna elements 20, a processing unit 30, and a baseband processing unit 40. The configuration of the two antenna elements 20 is the same as the configuration of the two antenna elements 20 of the antenna module according to the second embodiment (FIG. 6), and the antenna elements 20 transmit a linearly polarized wave 82. The processing unit 30 includes reception amplifiers 33, transmission amplifiers 34, variable attenuators 35, phase shifters 36, and a multiplexer/demultiplexer 37, as in the antenna module according to the second embodiment (FIG. 6). The processing unit 30 of the first antenna module 45 according to the third embodiment includes, in place of the receivers 31 and the reception level comparison and determination part 32 in the processing unit 30 of the antenna module according to the second embodiment (FIG. 6), a transmission controller 39. The transmission controller 39 selects a port to which a transmission signal is to be transmitted and adjusts the signal level of the transmission signal.

The baseband processing unit 40 includes a demodulator 41 and a reception level comparison part 42. The demodulator 41 demodulates a reception signal combined by the multiplexer/demultiplexer 37. The reception level comparison part 42 extracts reception level information contained in reception signals and compares reception levels. Functions of the reception level comparison part 42 will be described in detail later with reference to FIG. 14. The processing unit 30 and the baseband processing unit 40 do not necessarily correspond to hardware (integrated circuit elements) that implements the functions. For example, the functions of the demodulator 41 may be distributed to a radio frequency integrated circuit element (RFIC) that performs processing of signals in a high frequency range and a baseband integrated circuit element (BBIC) that performs processing of signals in a baseband frequency range.

The second antenna module 46 includes a transmitter/receiver 75 and a transmission/reception antenna 76 that performs transmission and reception of circularly polarized waves. In the case where the transmission/reception antenna 76 has characteristics of receiving circularly polarized waves, when a linearly polarized wave arrives, the reception sensitivity does not change depending on the polarization direction. In actuality, however, the transmission/reception antenna 76 has characteristics of having the highest sensitivity with respect to an elliptically polarized wave having a major axis in a certain direction. Thus, the reception sensitivity of the transmission/reception antenna 76 depends on the polarization direction of an incoming linearly polarized wave. To maintain a high reception sensitivity, it is desirable that the first antenna module 45 transmit a linearly polarized wave in a polarization direction in which a high reception sensitivity of the transmission/reception antenna 76 is obtained.

When receiving a radio wave, the transmitter/receiver 75 measures the reception level of the radio wave, and transmits, through the transmission/reception antenna 76, a reply signal containing information for identifying the reception level.

Next, the procedure of a process performed by the first antenna module 45 and the second antenna module 46 will be described with reference to FIG. 14. FIG. 14 is a flowchart illustrating the procedure of the process performed by the first antenna module 45 and the second antenna module 46.

First, the first antenna module 45 selects the port P0 from among the four ports of the two antenna elements 20 (FIG. 13) and supplies a test transmission signal to the selected port P0, so that the antenna element 20 is excited (step SC1). Thus, the linearly polarized wave 82 in a polarization direction corresponding to the port P0 to which the test transmission signal has been supplied is transmitted.

The second antenna module 46 receives the linearly polarized wave 82 that has come from the first antenna module 45 and measures the reception level (step SD1). Then, the second antenna module 46 transmits a reply signal 83 containing information for identifying the measured reception signal (step SD2). The first antenna module 45 receives the reply signal 83 from the second antenna module 46, and stores the information for identifying the reception signal contained in the reply signal 83 (step SC2). More specifically, the demodulator 41 (FIG. 13) demodulates the reply signal 83, and the reception level comparison part 42 (FIG. 13) stores the information for identifying the reception level.

The processing of steps SC1, SD1, SD2, and SC2 is performed for the remaining ports P1, P2, and P3. At this time, the signal levels of transmission signals transmitted from the first antenna module 45 are the same.

The reception level comparison part 42 of the first antenna module 45 (FIG. 13) detects the port at which the reception level of the linearly polarized wave received at the second antenna module 46 is the highest (step SC3). Information for identifying the port with the highest reception level is input to the transmission controller 39 (FIG. 13). The transmission controller 39 sets the amounts of change in signal level and the phase change amounts at the four ports P0, P1, P2, and P3 in such a manner that polarization directions of linearly polarized waves transmitted from the two antenna elements 20 become the same as the direction of the linearly polarized wave at the port at which the highest reception level is obtained (SC4). The amounts of change in signal level are set by adjusting the amounts of gain by the transmission amplifiers 34 and the amounts of attenuation by the variable attenuators 35.

After setting the amounts of change in signal level and the phase change amounts at the individual ports, the processing unit 30 transmits, through the two antenna elements 20, linearly polarized waves on the basis of the set amounts of change in signal level and the set phase change amounts (step SC5). The second antenna module 46 receives the linearly polarized waves transmitted from the first antenna module 45 (step SD3).

Next, advantageous effects in the third embodiment will be described.

In the third embodiment, the polarization direction in which the linearly polarized wave 82 is transmitted from the first antenna module 45 is adjusted so that the reception sensitivity of the second antenna module 46 becomes the maximum. Thus, more stable communication from the first antenna module 45 to the second antenna module 46 can be performed.

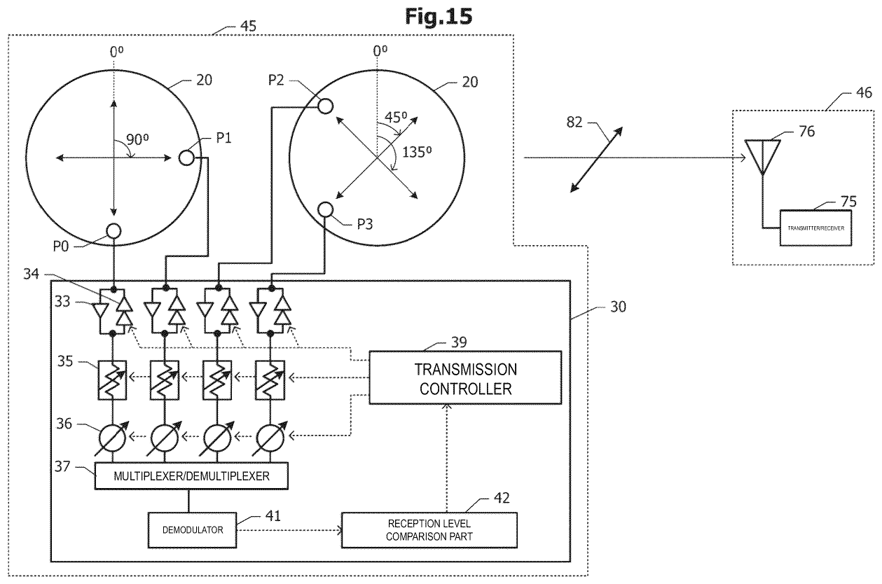

Next, an antenna system according to a modification of the third embodiment will be described with reference to FIG. 15. FIG. 15 is a schematic view of the antenna system according to the modification of the third embodiment. In the third embodiment (FIG. 13), the functions of the demodulator 41 and the reception level comparison part 42 are implemented by the baseband processing unit 40, which is provided separately from the processing unit 30 that performs processing for a high frequency range.

In the modification illustrated in FIG. 15, the demodulator 41 and the reception level comparison part 42 are included in the processing unit 30. For example, an integrated circuit element that performs processing of signals in a high frequency range has the functions of the demodulator 41 and the reception level comparison part 42. As described above, the integrated circuit element that performs processing of signals in the high frequency range may be provided with the functions of the demodulator 41 and the reception level comparison part 42.

### [Application of Antenna Modules According to Embodiments]

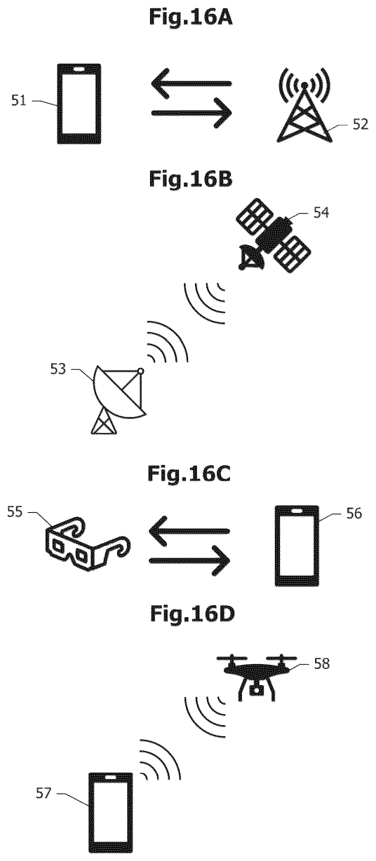

A communication system to which the antenna modules and the antenna systems according to the first to third embodiments are applied will be described with reference to FIGS. 16A to 16D. FIGS. 16A to 16D are schematic views of communication systems in which the antenna modules according to the embodiments described above are used.

The communication system illustrated in FIG. 16A includes a portable terminal 51 such as a smartphone and a base station 52. For example, the portable terminal 51 performs transmission and reception of linearly polarized waves, and the base station 52 performs transmission and reception of circularly polarized waves. The communication system illustrated in FIG. 16B includes a ground base station 53 and a communication satellite 54. The communication satellite 54 performs transmission and reception of linearly polarized waves, and the ground base station 53 performs transmission and reception of circularly polarized waves. A portable terminal moving on the ground, instead of the ground base station 53, and the communication satellite 54 may configure a communication system.

The communication system illustrated in FIG. 16C includes a virtual-reality/augmented-reality terminal 55 and a repeater 56. One of the virtual-reality/augmented-reality terminal 55 and the repeater 56 performs transmission and reception of linearly polarized waves, and the other one of the virtual-reality/augmented-reality terminal 55 and the repeater 56 performs transmission and reception of circularly polarized waves. Communication may be performed between a game machine or a smartphone, instead of the repeater 56, and the virtual-reality/augmented-reality terminal 55. The communication system illustrated in FIG. 16D includes a portable terminal 57 such as a smartphone and a drone 58 (unmanned aircraft). One of the portable terminal 57 and the drone 58 performs transmission and reception of linearly polarized waves, and the other one of the portable terminal 57 and the drone 58 performs transmission and reception of circularly polarized waves.

In the various communication systems illustrated in FIGS. 16A to 16D, by adopting an antenna module or an antenna system according to an embodiment described above, a deterioration in the reception sensitivity can be suppressed, and a stable communication can be ensured.

Each of the embodiments described above is illustrative and, obviously, components illustrated in different embodiments can be partially replaced or combined. Similar operational effects obtained by similar configurations in multiple embodiments will not be repeatedly described in each embodiment. Furthermore, the present disclosure is not limited to the embodiments described above. For example, various changes, improvements, combinations, and so on may be apparent to those skilled in the art.

### REFERENCE SIGNS LIST

20 antenna element
30 processing unit
31 receiver
32 reception level comparison and determination part
33 reception amplifier
34 transmission amplifier
35 variable attenuator
36 phase shifter
37 multiplexer/demultiplexer
38 transmitter/receiver
39 transmission controller
40 baseband processing unit
41 demodulator
42 reception level comparison part
45 first antenna module
46 second antenna module
51 portable terminal
52 base station
53 ground base station
54 communication satellite
55 virtual-reality/augmented-reality terminal
56 repeater
57 portable terminal
58 drone
72 transmission antenna
75 transmitter/receiver
76 transmission/reception antenna
80 elliptically polarized wave
81 trajectory of head of electric field vector of polarized wave
82 linearly polarized wave
83 reply signal

1. An antenna module comprising:
a plurality of antenna elements each including two ports that receive two linearly polarized waves that are orthogonal to each other, wherein polarization directions of the linearly polarized waves received at the two ports of the plurality of antenna elements are different among the plurality of antenna elements; and
circuitry configured to
process signals received at the plurality of antenna elements;
compare, among a plurality of ports included in the plurality of antenna elements, reception levels of linearly polarized components received at the plurality of ports; and
detect a port with the highest reception level.

2. The antenna module of claim 1, wherein
the number of the plurality of antenna elements is N (N represents an integer of 2 or more), and
the plurality of antenna elements receive linearly polarized waves in such a manner that polarization directions of the linearly polarized waves received at one ports of the plurality of antenna elements are different by 180/(2N) degrees.

3. The antenna module of claim 1, wherein
the circuitry is configured to control phase change amounts of reception signals output from the plurality of ports in such a manner that a phase of a component in a polarization direction of a linearly polarized wave received at the port with the highest reception level among the plurality of ports is the same among the plurality of ports included in the plurality of antenna elements.

4. The antenna module of claim 2, wherein
the circuitry is configured to control phase change amounts of reception signals output from the plurality of ports in such a manner that a phase of a component in a polarization direction of a linearly polarized wave received at the port with the highest reception level among the plurality of ports is the same among the plurality of ports included in the plurality of antenna elements.

5. The antenna module of claim 3, wherein
the circuitry includes a plurality of phase shifters that are connected to the plurality of ports of the plurality of antenna elements.

6. The antenna module of claim 5, wherein
the plurality of phase shifters are configured to control the phase change amounts of the reception signals output from the plurality of ports.

7. The antenna module of claim 3, wherein
the circuitry is configured to control amounts of change in signal level of the reception signals output from the two ports of the plurality of antenna elements in such a manner that polarization directions of radio waves received at the plurality of antenna elements are parallel to the polarization direction of the linearly polarized wave received at the port with the highest reception level among the plurality of ports.

8. The antenna module of claim 7, wherein
the circuitry includes at least one of a plurality of reception amplifiers and a plurality of variable attenuators that are connected to the plurality of ports of the plurality of antenna elements.

9. The antenna module of claim 8, wherein
the circuitry is configured to control the amounts of change in signal level by controlling at least one of amounts of gain by the plurality of reception amplifiers and amounts of attenuation by the plurality of variable attenuators.

10. An antenna system comprising:
a plurality of antenna elements each including two ports and transmitting and receiving, through the two ports, two linearly polarized waves in different polarization directions;
a first antenna module including circuitry configured to supply transmission signals to the plurality of antenna elements and process reception signals received at the plurality of antenna elements; and
a second antenna module configured to receive a radio wave transmitted from the first antenna module, measure a reception level, and send back to the first antenna module a signal containing information for identifying the measured reception level, wherein
polarization directions of the linearly polarized waves transmitted from the plurality of antenna elements are different among the plurality of antenna elements, and
the circuitry is configured to
perform, for each of the plurality of ports, processing for transmitting a linearly polarized wave by supplying a transmission signal to one of the plurality of ports of the plurality of antenna elements and then receive a reply signal sent back from the second antenna module; and
detect, based on the information contained in the reply signal for identifying the reception level, a port used when the reception level is the highest among the plurality of ports.

11. The antenna system of claim 10, wherein
the circuitry is configured to control amounts of change in signal level and phase change amounts of the transmission signals supplied to the two ports of the plurality of antenna elements in such a manner that the plurality of antenna elements emit linearly polarized waves in the same polarization direction as a polarization direction of a linearly polarized wave emitted from the port used when the reception level is the highest among the plurality of ports.

12. The antenna system of claim 11, wherein
the circuitry includes a plurality of phase shifters that are connected to the plurality of ports of the plurality of antenna elements.

13. The antenna system of claim 12, wherein
the plurality of phase shifters are configured to control phase change amounts of reception signals output from the plurality of ports.

14. The antenna system of claim 11, wherein
the circuitry includes at least one of a plurality of reception amplifiers and a plurality of variable attenuators that are connected to the plurality of ports of the plurality of antenna elements.

15. The antenna system of claim 14, wherein
the circuitry is configured to control the amounts of change in signal level by controlling at least one of amounts of gain by the plurality of reception amplifiers and amounts of attenuation by the plurality of variable attenuators.

16. The antenna system of claim 13, wherein
the circuitry includes at least one of a plurality of reception amplifiers and a plurality of variable attenuators that are connected to the plurality of ports of the plurality of antenna elements.

17. The antenna system of claim 16, wherein
the circuitry is configured to control the amounts of change in signal level by controlling at least one of amounts of gain by the plurality of reception amplifiers and amounts of attenuation by the plurality of variable attenuators.

18. A radio wave reception method for receiving a radio wave at a plurality of antenna elements each including two ports that receive two linearly polarized waves that are orthogonal to each other, polarization directions of the linearly polarized waves received at the two ports being different among the plurality of antenna elements, the method comprising:
acquiring reception signals from an incoming radio wave received at the two ports of the plurality of antenna elements;
comparing, among the plurality of ports, reception levels of linearly polarized components received at the plurality of ports of the plurality of antenna elements; and
detecting a port with the highest reception level.

19. The radio wave reception method of claim 18, wherein
amounts of change in signal level and phase change amounts at the two ports of the plurality of antenna elements are set in such a manner that a reception sensitivity for a linearly polarized wave received at the port with the highest reception level among the plurality of ports becomes the maximum, and communication is performed based on the set amounts of change in signal level and the set amounts of change.

20. The radio wave reception method of claim 19, further comprising:
determining that a reception level of a reception signal is below a determination threshold value during a period in which the communication is performed; and
detecting, responsive to the determining, a port with the highest reception level and repeating a process for setting amounts of change in signal level and phase change amounts at the two ports of the plurality of antenna elements.
